(19) United States
(12) Patent Application Publication
(10) Pub. No.: US 2008/0130415 A1
(43) Pub. Date: Jun. 5, 2008

(54) COMPOUND FLEXIBLE CIRCUIT AND METHOD FOR ELECTRICALLY CONNECTING A TRANSDUCER ARRAY

(75) Inventor: Alan Chi-Chung Tai, Phoenix, AZ (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/557,262

(22) Filed: Nov. 7, 2006

(51) Int. Cl. H04R 1/06; H04R 31/00

(52) U.S. Cl. 367/140; 29/594; 310/334

(57) ABSTRACT

A compound flexible circuit for electrically connecting a transducer array and a cable includes a first end configured to be coupled to the transducer array and a plurality of sections. Each section has a pitch and at least one of the plurality of sections has a variable pitch. The compound flexible circuit also includes a second end configured to be coupled to the cable. Various sections and/or portions of the variable pitch section may be removed to provide a pitch appropriate for the particular transducer array.

### FIELD OF THE INVENTION

The present invention relates generally to ultrasound systems and in particular to a flexible circuit for electrically connecting an ultrasound transducer array to a coaxial cable.

### BACKGROUND OF THE INVENTION

Ultrasound systems comprise an array of transducer elements used for transmitting a set of waveforms into an imaging subject and for receiving a set of backscattered ultrasound signals from the imaging subject. The transducer elements may be constructed of a piezoelectric material. The transducer array transmits ultrasound energy and receives backscattered ultrasound signals from the imaging subject to create and display an image. The backscattered signals are processed to create and display an image. In conventional ultrasound systems the transducer array is typically housed in an ultrasound probe for transmitting the ultrasound signals to an area to be examined as well as for receiving the scattered waves. A typical transducer probe consists of three basic parts: (1) a transducer package, (2) a multi-wire coaxial cable connecting the transducer to the rest of the ultrasound system, and (3) other miscellaneous mechanical hardware such as the probe housing, thermal/acoustic potting material and electrical shielding. The transducer package (sometimes referred to as a “pallet”) is typically produced by stacking layers.

Typically, one or more flexible printed circuit boards (hereinafter referred to as “flexible circuits”) are used to make electrical connections from the piezoelectric elements of the transducer array to a coaxial cable(s) which connect to signal processing electronics. Accordingly, the flexible circuit(s) act as the medium that connect the transducer array elements to coaxial cable(s) for interfacing with the ultrasound system. In one known technique, a fan out flexible circuit board, that is, a flexible circuit board having a plurality of etched conductive traces extending from a first terminal area that connects to the coaxial cables to a second terminal area that connects to the transducer elements, is used to electrically connect the transducer elements to a coaxial cable. The terminals of the first terminal area have a linear pitch greater than the linear pitch of the terminals in the second terminal area. Typically, the flexible circuit used is selected based on the required linear pitch of the transducer elements There are different types of ultrasound transducer arrays for different types of applications that require different geometries and different pitches for the array elements. Each type of transducer may require a different type of flexible circuit and a certain types of flexible circuits may not be compatible with the different transducer pitches.

Accordingly, it would be desirable to provide a compound flexible circuit that is compatible with multiple types of transducers. It would also be desirable to provide a compound flexible circuit that includes a variable pitch section that can be configured to fit the different pitches of different types of transducers. Such a compound flexible circuit could provide commonality and ease of use.

### BRIEF DESCRIPTION OF THE INVENTION

In accordance with an embodiment, a compound flexible circuit for electrically connecting a transducer array and a cable, includes a first end configured to be coupled to the transducer array, a plurality of sections, each section having a pitch and at least one of the plurality of sections having a variable pitch, and a second end configured to be coupled to the cable.

In accordance with another embodiment, a method for electrically connecting a transducer array and a cable includes providing a compound flexible circuit comprising a first end, a second end and a plurality of sections, each section having a pitch and at least one of the plurality of sections having a variable pitch, removing at least one section of the plurality of sections so that the first end has a predetermined pitch, coupling the first end to the transducer array, and coupling the second end to the cable.

### BRIEF DESCRIPTION OF THE DRAWINGS

The invention will become more fully understood from the following detailed description, taken in conjunction with the accompanying drawings, wherein like reference numerals refer to like parts, in which:

FIG. 1 is a schematic block diagram of an exemplary ultrasound system.

FIG. 2 shows a compound flexible circuit having a plurality of pitch sections in accordance with an embodiment.

FIG. 3 shows a compound flexible circuit embedded in a backing block in accordance with an embodiment.

FIG. 4 shows a compound flexible circuit and transducer acoustic stack in accordance with an embodiment.

### DETAILED DESCRIPTION

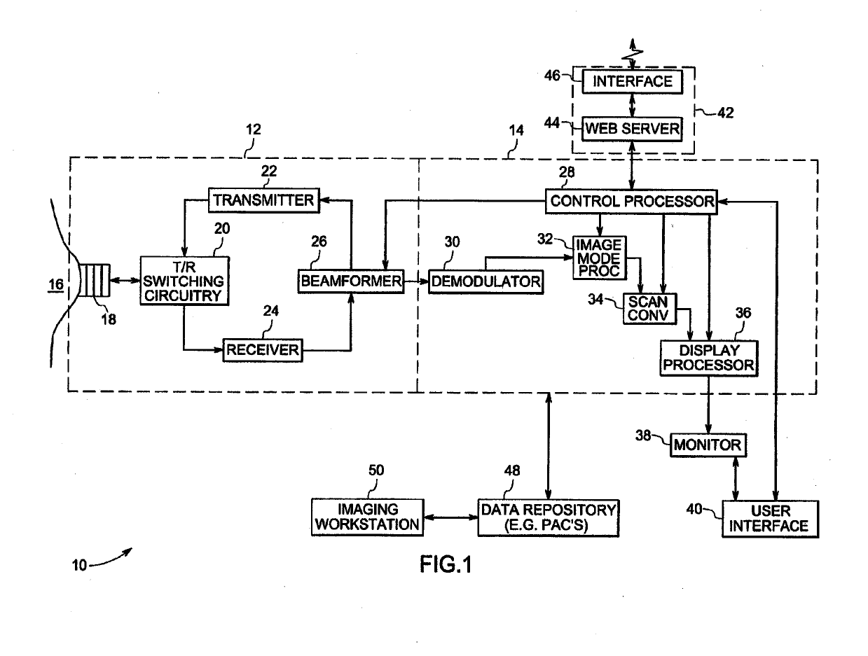

FIG. 1 is a schematic block diagram of an exemplary ultrasound system. The ultrasound system 10 includes an acquisition subsystem 12 and a processing subsystem 14. The acquisition subsystem 12 includes a transducer array 18 (having a plurality of transducer array elements), transmit/receive switching circuitry 20, a transmitter 22, a receiver 24, and a beamformer 26. The processing subsystem 14 includes a control processor 28, a demodulator 30, an imaging mode processor 32, a scan converter 34 and a display processor 36. The display processor 36 is further coupled to a display monitor 38 for displaying images. User interface 40 interacts with the control processor 28 and the display monitor 38. The control processor 28 may also be coupled to a remote connectivity subsystem 42 including a web server 44 and a remote connectivity interface 46. The processing subsystem 14 may be further coupled to a data repository 48 configured to receive ultrasound image data. The data repository 48 interacts with imaging workstation 50.

The aforementioned components may be dedicated hardware elements such as circuit boards with digital signal processors or may be software running on a general-purpose computer or processor such as a commercial, off-the-shelf personal computer (PC). The various components may be combined or separated according to various embodiments. Thus, those skilled in the art will appreciate that the present ultrasound system 10 is provided by way of example, and the present techniques are in no way limited by the specific system configuration.

In the acquisition subsystem 12, the transducer array 18 is in contact with a patient or subject 16. The transducer array 18 is coupled to the transmit/receive (T/R) switching circuitry 20. The T/R switching circuitry 20 is coupled to the output of transmitter 22 and the input of the receiver 24. The output of the receiver 24 is an input to the beamformer 26. The beamformer 26 is further coupled to the input of the transmitter 22 and to the input of the demodulator 30. The beamformer 26 is also coupled to the control processor 28 as shown in FIG. 1.

In the processing subsystem 14, the output of demodulator 30 is coupled to an input of an imaging mode processor 32. The control processor 28 interfaces with the imaging mode processor 32, the scan converter 34 and the display processor 36. An output of imaging mode processor 32 is coupled to an input of scan converter 34. An output of the scan converter 34 is coupled to an input of the display processor 36. The output of display processor 36 is coupled to the monitor 38.

The ultrasound system 10 transmits ultrasound energy into the subject 16 and receives and processes backscattered ultrasound signals from the subject 16 to create and display an image. To generate a transmitted beam of ultrasound energy, the control processor 28 sends command data to the beamformer 26 to generate transmit parameters to create a beam of a desired shape originating from a certain point at the surface of the transducer array 18 at a desired steering angle. The transmit parameters are sent from the beamformer 26 to the transmitter 22. The transmitter 22 uses the transmit parameters to properly encode transmit signals to be sent to the transducer array 18 through the T/R switching circuitry 20. The transmit signals are set at certain levels and phases with respect to each other and are provided to individual transducer elements of the transducer array 18. The transmit signals excite the transducer elements to emit ultrasound waves with the same phase and level relationships. As a result, a transmitted beam of ultrasound energy is formed in a subject 16 within a scan plane along a scan line when the transducer array 18 is acoustically coupled to the subject 16 by using, for example, ultrasound gel. The process is known as electronic scanning.

The transducer array 18 is a two-way transducer. When ultrasound waves are transmitted into a subject 16, the ultrasound waves are backscattered off the tissue and blood samples within the subject 16. The transducer array 18 receives the backscattered waves at different times, depending on the distance into the tissue they return from and the angle with respect to the surface of the transducer array 18 at which they return. The transducer elements convert the ultrasound energy from the backscattered waves into electrical signals.

The electrical signals are then routed through the T/R switching circuitry 20 to receiver 24. The receiver 24 amplifies and digitizes the received signals and provides other functions such as gain compensation. The digitized received signals corresponding to the backscattered waves received by each transducer element at various times preserve the amplitude and phase information of the backscattered waves.

The digitized signals are sent to the beamformer 26. The control processor 28 sends command data to beamformer 26. The beamformer 26 uses the command data to form a receive beam originating from a point on the surface of the transducer array 18 at a steering angle typically corresponding to the point and steering angle of the previous ultrasound beam transmitted along a scan line. The beamformer 26 operates on the appropriate received signals by performing time delaying and focusing, according to the instructions of the command data from the control processor 28, to create received beam signals corresponding to sample volumes along a scan line in the scan plane within the subject 16. The phase, amplitude, and timing information of the received signals from the various transducer elements is used to create the received beam signals.

The received beam signals are sent to the processing subsystem 14. The demodulator 30 demodulates the received beam signals to create pairs of I and Q demodulated data values corresponding to sample volumes within the scan plane. Demodulation is accomplished by comparing the phase and amplitude of the received beam signals to a reference frequency. The I and Q demodulated data values preserve the phase and amplitude information of the received signals.

The demodulated data is transferred to the imaging mode processor 32. The imaging mode processor 32 uses parameter estimation techniques to generate imaging parameter values from the demodulated data in scan sequence format. The imaging parameters may include parameters corresponding to various possible imaging modes such as B-mode, color velocity mode, spectral Doppler mode, and tissue velocity imaging mode, for example. The imaging parameter values are passed to the scan converter 34. The scan converter 34 processes the parameter data by performing a translation from scan sequence format to display format. The translation includes performing interpolation operations on the parameter data to create display pixel data in the display format.

The scan converted pixel data is sent to the display processor 36 to perform any final spatial or temporal filtering of the scan converted pixel data, to apply grayscale or color to the scan converted pixel data, and to convert the digital pixel data to analog data for display on the monitor 38. The user interface 40 is coupled to the control processor 28 to allow a user to interface with the ultrasound system 10 based on the data displayed on the monitor 38.

As mentioned above, the transducer array 18 is coupled to signal processing circuitry, in particular, to T/R switching circuitry 20. Signals are sent to and received from the transducer array 18. Transducer array 18 may be coupled to T/R switching circuitry 20 via a coaxial cable or cables (not shown). The transducer elements of transducer array 18 may be electrically connected to a coaxial cable using one or more flexible printed circuit boards (or “flexible circuit”). Different types of transducer arrays for ultrasound systems may require different geometries and pitches. Accordingly, a flexible circuit may be used that comprises a plurality of sections, each section having a different pitch or a variable pitch, so that the flexible circuit may be customized or adapted to the appropriate pitch for a plurality of types of transducer arrays.

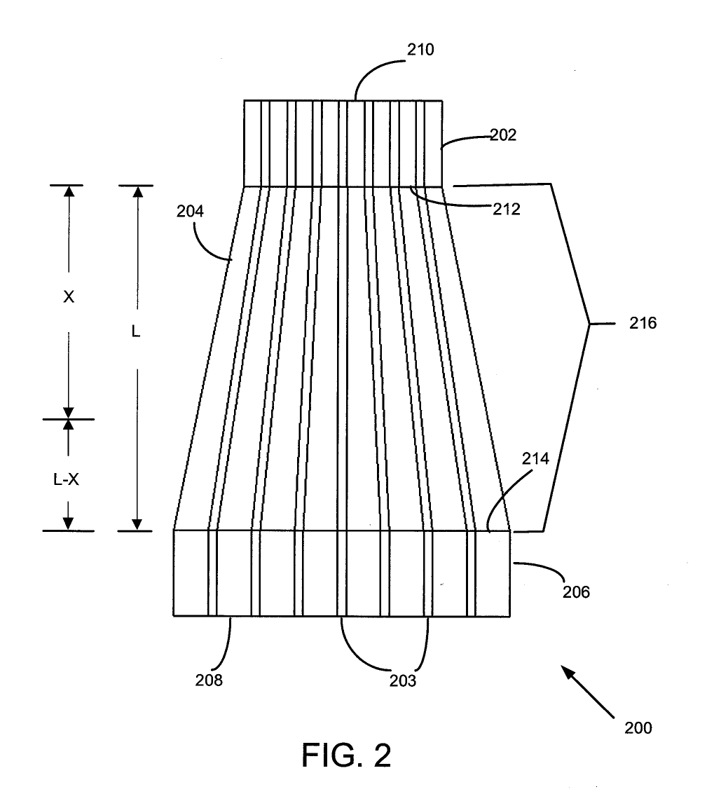

FIG. 2 shows a compound flexible circuit having a plurality of pitch sections in accordance with an embodiment. Compound flexible circuit 200 is configured to accommodate different pitches for different types of transducer arrays. Compound flexible circuit 200 includes a plurality of electrical conductors or conductive traces 203 that may be covered in a dialectric material such as polyamide. Alternatively, the compound flexible circuit 200 with conductive traces 203 may be embedded inside a rigid printed circuit board made of, for example, FR4. While FIG. 2 illustrates a compound flexible circuit 200 with seven conductive traces 203, it is to be understood that compound flexible circuit 200 can be configured to include any number of conductive traces 203 (e.g., one hundred or more). Compound flexible circuit 200 includes a first section 202 with a first pitch (A), a second section 204 with a second pitch (B) and a third section 206 with a third pitch (C). A front side 208 of the compound flexible circuit 200 may connect to a transducer array with a third pitch (C) configuration. A backside 210 of compound flexible circuit 200 may be connected to a cable (not shown). For example, backside 210 may be connected to a cable through connectors that are located in an extended section (not shown) of backside 210 or individual coaxial cables (not shown) within the cable may be soldered directly into pads (not shown) that connect the electrical conductors 203 of the compound flexible circuit 200. Other methods for connection generally known in the art of transducer assemblies may be used to connect the compound flexible circuit 200 to the cable. A front side 214 of the second section 204 has a pitch (C) which is the same pitch of section 206. As discussed further below, second section 204 is also configured to provide a variable pitch (Y) in section 216.

Sections of the compound flexible circuit 200 may be trimmed or cut away to provide a flexible circuit with the appropriate pitch for the transducer array to which the flexible circuit will be connected. For example, for a transducer array (not shown) requiring the first pitch (A), the third 206 and second 204 sections of the flexible circuit 200 may be trimmed or cut away so that the first section 202 with the first pitch (A) remains. A front side 212 of the first section 202 with the first pitch (A) may then be connected to the transducer array (not shown). In another example, for a transducer array requiring a second pitch (B), the third section 206 is trimmed or cut away so that a front side 214 of the second section 204 with the second pitch (B) is available to be connected to the transducer array. Methods generally known in the art may be used to connect the flexible circuit 200 to a transducer array (not shown) and a cable (not shown). In alternative embodiments, a compound flexible circuit may be provided that includes any number of sections, each section having a different pitch or a variable pitch (e.g., a fourth section with a fourth pitch, a fifth section with a fifth pitch, a sixth section with a sixth pitch, and so on). Accordingly, a compound flexible circuit 200 can be configured so that it may be adapted to fit multiple different types of transducer arrays and the pitches required for the different transducers arrays.

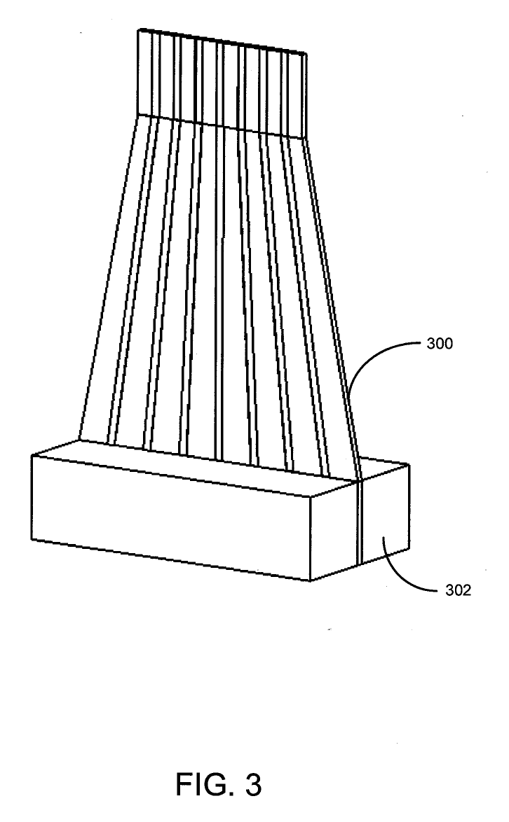

Compound flexible circuit 200 may connect to a transducer array either in a horizontal or a vertical position. When the compound flexible circuit is connected to a transducer array in a vertical position, the flexible circuit requires support to maintain a vertical position. In one embodiment, a secure connection with a flexible circuit in a vertical position is achieved by embedding the flexible circuit inside of a backing block. FIG. 3 shows a compound flexible circuit embedded in a backing block in accordance with an embodiment. Compound flexible circuit 300 is embedded in a backing block 302. In one embodiment, the compound flexible circuit 300 may be trimmed to provide the appropriate pitch for a transducer array before the compound flexible circuit 300 is embedded in the backing block 302. Alternatively, both the backing block 302 and compound flexible circuit 300 are trimmed (i.e., after the compound flexible circuit 300 is embedded in the backing block 302) to provide an appropriate pitch for a particular transducer array. Backing block 302 is used to support the compound flexible circuit 300, to support a transducer array (not shown), and to attenuate or absorb acoustic energy that may be transmitted in a backwards direction from the transducer array. Backing block 302 is made of an acoustic damping material, for example, tungsten doped epoxy.

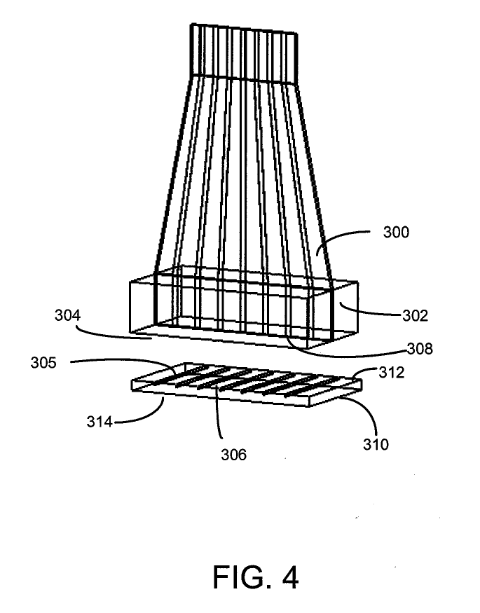

FIG. 4 shows a compound flexible circuit and a transducer acoustic stack in accordance with an embodiment. Backing block 302 may be bonded to a transducer array, for example, a transducer acoustic stack 310. A transducer array is typically produced by stacking layers in sequence. Transducer acoustic stack 310 is an assembly of piezoelectric ceramic matching layers and includes a multiple transducer elements 306 made of piezoelectric material. The transducer element pattern (e.g., rows of transducer elements that form an array) on transducer acoustic stack 310 may be formed using known methods and devices such as a dicing saw or a laser. Also formed on the transducer acoustic stack 310 (e.g., by cutting with a dicing saw or laser) are a plurality of narrow slots referred to as kerfs 305. Each narrow slot or kerf 305 acts to electrically and acoustically isolate one element 306 from adjacent elements 306. A rear surface 312 of transducer acoustic stack 310 may be coated with metal. As mentioned above, compound flexible circuit 300 may be embedded in a backing block 302. Compound flexible circuit 300 includes a plurality of conductive traces 308 that are exposed at a front surface 304 of the backing block 302. The front surface 304 of backing block 302 may be coated with metal (e.g., gold) so that the exposed traces 308 are electrically connected to the metal coating. Each individual trace 308 may have its own region of electrically connected pattern that corresponds to an individual transducer element 306 of the transducer acoustic stack 310. The pattern of the front surface 304 of backing block 302 may be formed using known methods and devices such as a dicing saw or laser. Preferably, the element pattern in the front surface 304 of backing block 302 and the rear surface 312 of transducer acoustic stack 310 are identical. Backing block 302 may be bonded to transducer acoustic stack 310 using, for example, an epoxy. Methods generally known in the art may be used to bond backing block to a transducer array. Preferably, backing block 302 is bonded to a transducer acoustic stack 310 so that only the exposed traces 308 in the front surface 304 of backing block 302 are in direct contact with the transducer elements 306 of transducer acoustic stack 310. Alternatively, the transducer acoustic stack 310 may be bonded to the front surface 304 of backing block 302 before a dicing operation is performed to form the transducer elements 306. The dicing operation can cut from the front surface 314 of the transducer acoustic stack 310 through the stack layers (e.g., matching layers, ceramic) into the backing block 302. FIG. 4 illustrates one compound flexible circuit 300 in backing block 302. Alternatively, multiple flexible circuits 300 may be placed between multiple backing blocks 302 to build up a transducer in one dimensional (1D), one and a half dimensional (1.5D) or two-dimensional (2D) arrays that are generally known in the art of transducer assemblies.

Returning to FIG. 2, as mentioned above the compound flexible circuit 200 may include a variable pitch (Y) section 216. In the embodiment shown in FIG. 2, second section 204 may be used as a variable pitch section 216. Variable pitch section 216 may be used to provide a flexible circuit with a pitch (Y) that is less than the third pitch (C) of the third section 206 and greater than the first pitch (A) of the first section 202. Variable pitch section 216 has a length, L, which is also the distance between the first section 202 and the third section 206. A plurality of different pitches may be provided using the variable pitch section 216 and the pitch depends on the amount of variable pitch section 216 that is trimmed along the length, L, of the variable pitch section 216. The amount of the length, L, of the variable pitch section 216 left after trimming is designated by the distance X in FIG. 2 and the amount of the length, L, of the variable pitch section 216 trimmed away is designated by the distance L-X in FIG. 2.

In one embodiment, the variable pitch, Y, at a particular point along the length of the variable pitch section 216 is given by the following equation:

Y=A+(X/L)*(C−A) (Equation 1)

Where A is the pitch of the first section 202, C is the pitch of the third section 206, L is the length of the variable pitch section 216, and X is the amount of the variable pitch section length that remains after trimming the variable pitch section 216. Equation 1 shows the relationship of the amount of the variable pitch section that remains, X, and the variable pitch, Y, and defines the geometry of the variable pitch section 216. As described above with respect to FIG. 3, in one embodiment, the compound flexible circuit may be embedded in a backing block and both the backing block and the compound flexible circuit may be trimmed to provide the appropriate pitch.

Returning to FIG. 2, when a particular pitch, Y, is required for a particular transducer with pitch, Y, the amount of length of the variable pitch section (e.g., the variable pitch section embedded inside the backing block) that should be trimmed away or removed, L−X, may be determined by the following equation:

L−X=((C−Y)/(C−A))*L (Equation 2)

Once the first section 202 and the appropriate amount, L−X, of the variable pitch section 216 have been trimmed away to provide a pitch, Y, the compound flexible circuit 200 may be connected to a transducer array requiring pitch Y. As mentioned above, a plurality of different pitches may be provided using variable pitch section 216. In one example, a variable pitch (Y) of 200 μm is required using a compound flexible circuit 200 where the first pitch (A) of first section 202 is 100 μm, the third pitch (C) of the third section is 300 μm and the length (L) of the variable pitch section 216 is 20 mm. Using Equation 2, the amount of the variable pitch section 216 that needs to be trimmed away, L−X, is 10 mm. Accordingly, 10 mm of the variable pitch section 216 would be trimmed away from the front 214 of the variable pitch section to generate a compound flexible circuit 200 with a pitch of 200 μm.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. The order and sequence of any process or method steps may be varied or re-sequenced according to alternative embodiments.

Many other changes and modifications may be made to the present invention without departing from the spirit thereof. The scope of these and other changes will become apparent from the appended claims.

We claim:

1. A compound flexible circuit for electrically connecting a transducer array and a cable, the compound flexible circuit comprising:
a first end configured to be coupled to the transducer array;
a plurality of sections, each section having a pitch and at least one of the plurality of sections having a variable pitch; and
a second end configured to be coupled to the cable.

2. A compound flexible circuit according to claim 1, wherein the plurality of sections are embedded in a backing material.

3. A compound flexible circuit according to claim 1, wherein the variable pitch is defined by at least a length of the section having the variable pitch.

4. A compound flexible circuit according to claim 1, wherein the transducer array has a first pitch and at least one of the plurality of sections has the first pitch.

5. A compound flexible circuit according to claim 1, wherein the second end is configured to be coupled to a coaxial cable.

6. A compound flexible circuit according to claim 1, wherein the first end is configured to be coupled to an ultrasound system transducer array.

7. A compound flexible circuit according to claim 1, wherein each section of the plurality of sections has a different pitch.

8. A compound flexible circuit according to claim 1, wherein the pitch of each section of the plurality of sections corresponds to a pitch of a transducer array.

9. A compound flexible circuit according to claim 2, wherein the backing material is configured to be coupled to the transducer array.

10. A method for electrically connecting a transducer array and a cable, the method comprising:
providing a compound flexible circuit comprising a first end, a second end and a plurality of sections, each section having a pitch and at least one of the plurality of sections having a variable pitch;
removing at least one section of the plurality of sections so that the first end has a predetermined pitch;
coupling the first end to the transducer array; and
coupling the second end to the cable.

11. A method according to claim 10, further comprising removing a predetermined length of a section having a variable pitch so that the first end has a predetermined pitch.

12. A method according to claim 10, wherein the variable pitch is defined by at least a length of the section having the variable pitch.

13. A method according to claim 10, wherein the predetermined pitch is the pitch of the transducer array.

14. A method according to claim 11, wherein the predetermined pitch is the pitch of the transducer array.

15. A method according to claim 10, wherein the cable is a coaxial cable.

16. A method according to claim 10, wherein the transducer array is an ultrasound system transducer array.
